(19) United States
(12) Patent Application Publication
(10) Pub. No.: US 2014/0170614 A1
(43) Pub. Date: Jun. 19, 2014

(54) PROVIDING A USER-SPECIFIC EFFORT VALUE ASSOCIATED WITH DIGITAL TEXTUAL CONTENT

(71) Applicant: INTERNATIONAL BUSINESS MACHINES CORPORATION, (US)

(72) Inventors: Gary D. CUDAK, Creedmoor, NC (US); Lydia M. DO, Raleigh, NC (US); Christoper J. HARDEE, Raleigh, NC (US); Adam ROBERTS, Moncure, NC (US)

(73) Assignee: INTERNATIONAL BUSINESS MACHINES CORPORATION, Armonk, NY (US)

(21) Appl. No.: 13/716,847

(22) Filed: Dec. 17, 2012

(51) Int. Cl. G09B 17/04

(52) U.S. Cl. CPC G09B 17/04
USPC 434/179

(57) ABSTRACT

Methods, apparatuses, and computer program products are provided for providing a user-specific effort value associated with digital textual content. Typical embodiments include identifying a user read speed value; identifying a complexity value for a particular work of authorship; and calculating, in dependence upon the user read speed value and the complexity value, an individualized effort value for the work of authorship.

### BACKGROUND OF THE INVENTION

1. Field of the Invention

The field of the invention is data processing, or, more specifically, methods, apparatus, and products for providing a user-specific effort value associated with digital textual content.

2. Description of Related Art

An e-book reader is a portable electronic device that is designed primarily for the purpose of reading digital books and periodicals. E-book readers are often similar in form to a tablet computer. A tablet computer typically has a faster screen capable of higher refresh rates which makes them more suitable for interaction. The main advantages of e-book readers are better readability of their screens especially in bright sunlight and longer battery life. This is often achieved by using electronic paper technology to display content to readers. Any device or application that can display text on a screen, such as a tablet computer, a mobile phone, a laptop or other computer, can act as an e-book reader, but often they operate the advantages of the e-paper technology.

Current eBooks and other digital textual content are typically served up by servers that allow users to download the digital textual content. Such servers allow users to view information about the digital textual content prior to download but provide little or no information as to the complexity of the digital textual content.

### SUMMARY OF THE INVENTION

Methods, apparatuses, and computer program products are provided for providing a user-specific effort value associated with digital textual content. Typical embodiments include identifying a user read speed value; identifying a complexity value for a particular work of authorship; and calculating, in dependence upon the user read speed value and the complexity value, an individualized effort value for the work of authorship.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram of a system for providing a user-specific effort value associated with digital textual content according to embodiments of the present invention.

FIG. 2 sets forth a block diagram of automated computing machinery comprising an exemplary eBook server useful in providing a user-specific effort value associated with digital textual content, according to embodiments of the present invention.

FIG. 3 sets forth a flowchart illustrating an example method for automatically providing a user-specific effort rating associated with digital textual content according to embodiments of the present invention.

FIG. 4 sets forth a flow chart illustrating an additional example method for providing a user-specific effort value associated with digital textual content.

FIG. 5 sets forth a flow chart illustrating an additional example method for providing a user-specific effort value associated with digital textual content.

### DETAILED DESCRIPTION OF EXEMPLARY EMBODIMENTS

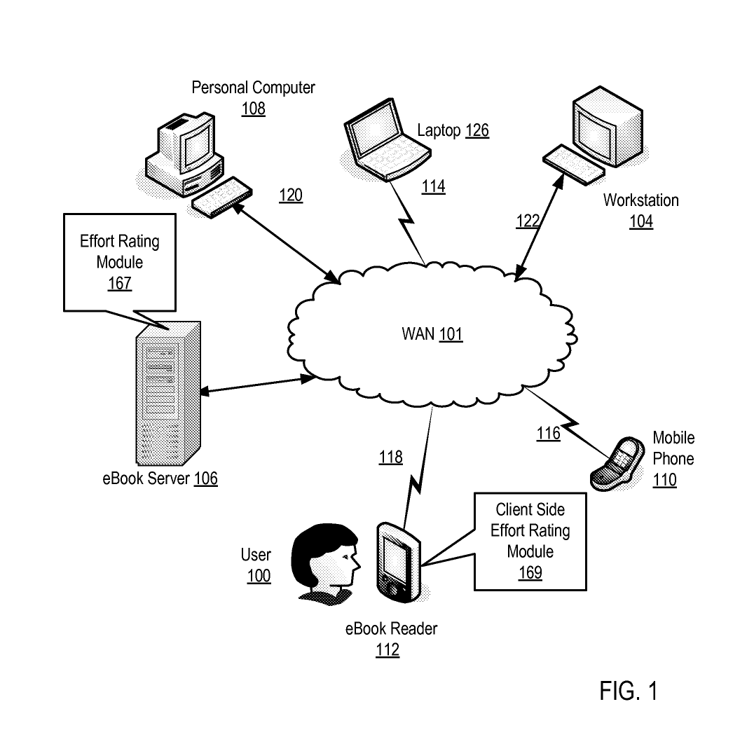

Example methods, apparatus, and products for a user-specific effort value associated with digital textual content in accordance with the present invention are described with reference to the accompanying drawings, beginning with FIG. 1. FIG. 1 sets forth a network diagram of a system for providing a user-specific effort value associated with digital textual content according to embodiments of the present invention. The system of FIG. 1 includes a number of devices that can function as readers for digital textual content such as an eBook reader (112), a mobile phone (110) with a digital reader application installed upon it, a workstation (104) with a digital reader application installed upon it, a laptop (126) with a digital reader application installed upon it, and a personal computer (108) with a digital reader application installed upon it. The devices (112, 110, 104, 126, and 108) are coupled for data communications with an eBook server (106). The eBook server provides digital textual content to be read on one or more of the devices. Examples of such eBook servers are servers operated by Amazon.com, Barnes & Noble and other providers of digital textual content.

The eBook server (106) of FIG. 1 includes an effort rating module (167) that includes computer program instructions for providing a user-specific effort value associated with digital textual content. A user specific effort rating is a value that is individualized for a particular user and provides an indication as to the relative effort for the user to read the digital textual content. A user specific effort value may be a numeric value, an alphanumeric value, a descriptive value or any other value that will occur to those of skill in the art.

The effort rating module (167) installed on the eBook server (106) of FIG. 1 includes computer program instructions that when executed identify a user read speed value; identify a complexity value for a particular work of authorship; calculate, in dependence upon the user read speed value and the complexity value, an individualized effort value for the work of authorship; and presents to the user the individualized effort level value.

Installed on each of the devices (112, 110, 104, 126, and 108) is a client side effort rating module that operates with the effort rating module (167) on the eBook server to provide information about the user (100) such that the eBook server may provide the user specific effort value to the user. Such information may be a calculated read speed value for the user, a read speed value provided by the user, examples of other works of authorship being read by the user, and other information about the user that will occur to those of skill in the art. This information about the user is often stored in a user profile on the eBook server.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

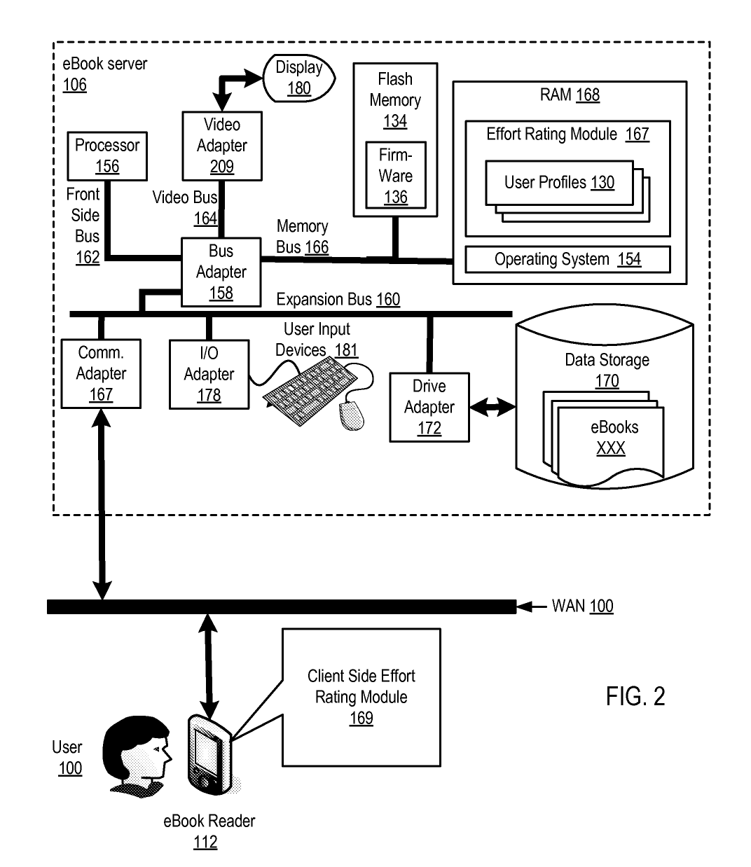

Providing a user-specific effort value associated with digital textual content, in accordance with the present invention is generally implemented with computers, that is, with automated computing machinery. In the system of FIG. 1, for example, all the servers and client devices are implemented to some extent at least as computers. For further explanation, therefore, FIG. 2 sets forth a block diagram of automated computing machinery comprising an exemplary eBook server (106) useful in providing a user-specific effort value associated with digital textual content, according to embodiments of the present invention. The eBook server (106) of FIG. 2 includes at least one computer processor (156) or ‘CPU’ as well as random access memory (168) (‘RAM’) which is connected through a high speed memory bus (166) and bus adapter (158) to processor (156) and to other components of the eBook server (106).

Stored in RAM (168) is a effort rating module (167), a module of computer program instructions for providing a user-specific effort value associated with digital textual content. Also stored RAM (168) is a set of user profiles (130) containing information about users such as their read speed values, client devices used to read digital textual content, purchased works of authorship, and other information that will occur to those of skill in the art.

Also stored in RAM (168) is an operating system (154). Operating systems useful providing a user-specific effort value associated with digital textual content, according to embodiments of the present invention include UNIX™, Linux™, Microsoft XP™, AIX™, IBM's i5/OS™, and others as will occur to those of skill in the art. The operating system (154), effort rating module (167), user profiles (130) in the example of FIG. 2 are shown in RAM (168), but many components of such software typically are stored in non-volatile memory also, such as, for example, on a disk drive (170).

The eBook server (106) of FIG. 2 includes disk drive adapter (172) coupled through expansion bus (160) and bus adapter (158) to processor (156) and other components of the eBook server (106). Disk drive adapter (172) connects non-volatile data storage to the eBook server (106) in the form of disk drive (170). Disk drive adapters useful in computers for providing a user-specific effort value associated with digital textual content, according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example eBook server (106) of FIG. 2 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example eBook server (106) of FIG. 2 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary eBook server (106) of FIG. 2 includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for providing a user-specific effort value associated with digital textual content, according to embodiments of the present invention include modems for wired dial-up communications, Ethernet (IEEE 802.3) adapters for wired data communications network communications, and 802.11 adapters for wireless data communications network communications.

Also illustrated in FIG. 2 is an eBook reader (112), a dedicated client device for downloading, displaying, and reading digital textual content. The eBook reader (112) of FIG. 2 includes a client side effort rating module (169) that is a module of computer program instructions for receiving or calculating a user read speed value and for transmitting the user read speed value to the eBook server (106) of FIG. 2. The client side effort rating module of FIG. 2 is also capable of displaying information such as an individualized effort value, predicted length of time to read a work of authorship and other information to the user.

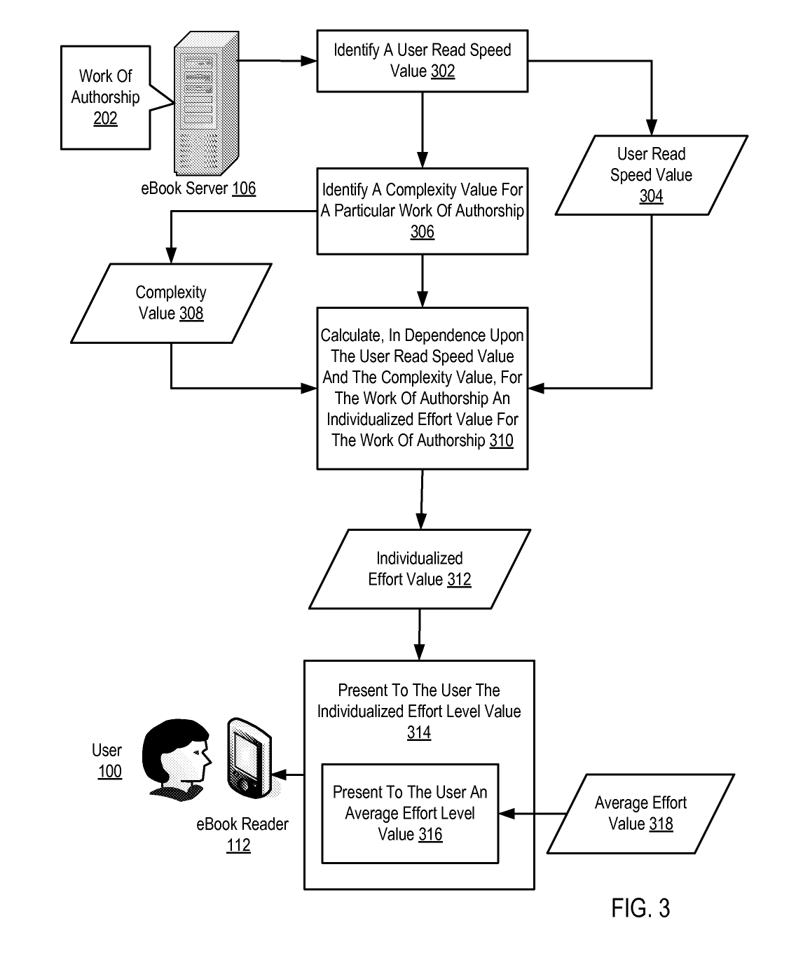

For further explanation, FIG. 3 sets forth a flowchart illustrating an example method for automatically providing a user-specific effort rating associated with digital textual content according to embodiments of the present invention. The method of FIG. 3 includes identifying (302) a user read speed value (304). Identifying (302) a user read speed value (304) may be carried out by receiving from a user through a client device previous value calculated by a school or other professional or professional organization.

Identifying (302) a user read speed value (304) may be carried out by receiving from a client device a user read speed value that is calculated on a client device such as a dedicated eBook reader, client application, or the like. Such a client device may calculate a user read speed value by analyzing the font of a page and rate of page turning on a dedicated reading device, such as an eBook reader, or other digital textual content reading application and then transmit the user read speed value to an effort rating module operating on a server.

Identifying (302) a user read speed value (304) alternatively may be carried out by receiving from a client device a user read speed value that is calculated on a client device using analysis of data from eye trackers. Eye trackers measure rotations of the eye in one of several ways, but principally they fall into three categories:

One type uses an attachment to the eye, such as a special contact lens with an embedded mirror or magnetic field sensor, and the movement of the attachment is measured with the assumption that it does not slip significantly as the eye rotates. Measurements with tight fitting contact lenses have provided extremely sensitive recordings of eye movement, and magnetic search coils are the method of choice for researchers studying the dynamics and underlying physiology of eye movement.

The second broad category uses some non-contact, optical method for measuring eye motion. Light, typically infrared, is reflected from the eye and sensed by a video camera or some other specially designed optical sensor. The information is then analyzed to extract eye rotation from changes in reflections. Video based eye trackers typically use the corneal reflection (the first Purkinje image) and the center of the pupil as features to track over time. A more sensitive type of eye tracker, the dual-Purkinje eye tracker, uses reflections from the front of the cornea (first Purkinje image) and the back of the lens (fourth Purkinje image) as features to track. A still more sensitive method of tracking is to image features from inside the eye, such as the retinal blood vessels, and follow these features as the eye rotates. Optical methods, particularly those based on video recording, are widely used for gaze tracking and are favored for being non-invasive and inexpensive.

The third category uses electric potentials measured with electrodes placed around the eyes. The eyes are the origin of a steady electric potential field, which can also be detected in total darkness and if the eyes are closed. It can be modeled to be generated by a dipole with its positive pole at the cornea and its negative pole at the retina. The electric signal that can be derived using two pairs of contact electrodes placed on the skin around one eye is called Electrooculogram (EOG). If the eyes move from the centre position towards the periphery, the retina approaches one electrode while the cornea approaches the opposing one. This change in the orientation of the dipole and consequently the electric potential field results in a change in the measured EOG signal. Inversely, by analyzing these changes in eye movement can be tracked. Due to the discretisation given by the common electrode setup two separate movement components—a horizontal and a vertical—can be identified. A third EOG component is the radial EOG channel, which is the average of the EOG channels referenced to some posterior scalp electrode. This radial EOG channel is sensitive to the saccadic spike potentials stemming from the extra-ocular muscles at the onset of saccades, and allows reliable detection of even miniature saccades.

Due to potential drifts and variable relations between the EOG signal amplitudes and the saccade sizes make it challenging to use EOG for measuring slow eye movement and detecting gaze direction. EOG is, however, a very robust technique for measuring saccadic eye movement associated with gaze shifts and detecting blinks. Contrary to video-based eye-trackers, EOG allows recording of eye movements even with eyes closed, and can thus be used in sleep research. It is a very light-weight approach that, in contrast to current video-based eye trackers, only requires very low computational power, works under different lighting conditions and can be implemented as an embedded, self-contained wearable system. It is thus the method of choice for measuring eye movement in mobile daily-life situations and REM phases during sleep.

The method of FIG. 3 also includes identifying (308) a complexity value (308) for a particular work of authorship (202). Identifying (308) a complexity value (308) for a particular work of authorship (202) may be carried out using readability tests, readability formulas, or readability metrics. Readability tests, readability formulas, or readability metrics are formulae for evaluating the readability of text, usually by counting syllables, words, and sentences. Readability tests are often used as an alternative to conducting an actual statistical survey of human readers of the subject text (a readability survey). Some word processing applications have readability tests built-in, which can be deployed on documents in-editing.

The application of a useful readability test protocol will give a rough indication of a work's readability, with accuracy increasing when finding the average readability of a large number of works. The tests generate a score based on characteristics such as statistical average word length (which is used as an unreliable proxy for semantic difficulty) and sentence length (as an unreliable proxy for syntactic complexity) of the work.

Some readability formulas refer to a list of words graded for difficulty. These formulas attempt to overcome the fact that some words, like “television”, are well known to younger children, but have many syllables. In practice, however, the utility of simple word and sentence length measures make them more popular for readability formulas. Scores are compared with scales based on judged linguistic difficulty or reading grade level. Many readability formulas measure word length in syllables rather than letters, but only SMOG has a computerized readability program incorporating an accurate syllable counter.

In some embodiments, identifying (308) a complexity value (308) for a particular work of authorship (202) may be carried out in dependence upon a known writing style or known parameters of a particular author. In some other embodiments, identifying (308) a complexity value (308) for a particular work of authorship (202) may be carried out through the use of book reviews or values created by a professional reviewer.

The method of FIG. 3 also includes calculating (310), in dependence upon the user read speed value (304) and the complexity value (308), an individualized effort value (312) for the work of authorship (202). Calculating (310), in dependence upon the user read speed value (304) and the complexity value (308), an individualized effort value (312) for the work of authorship (202) through the use of a formula incorporating the read speed value and the complexity value. Such an individualized effort value (312) may be represented in a numeric or alphanumeric effort value such as a value from 1-10, where the value 10 represents a highest degree of effort required for the user and 1 represents a lowest degree of effort for the user. In other embodiments of the present invention, an individualized effort value (312) may be represented may be represented descriptively such as through words such as hard, light, easy-reader, and others as will occur to those of skill in the art.

The method of FIG. 3 also includes presenting (314) to the user the individualized effort level value (312). Presenting (314) to the user the individualized effort level value (312) may be carried out by creating a presentation page including the individualized effort level value and transmitting the presentation page to a client device for display to the user.

In the example of FIG. 3 presenting (314) to the user the individualized effort level value (312) also includes presenting (316) to the user an average effort level value (318) of other users. Presenting (316) to the user an average effort level value (318) of other users allows a user to determine whether the work of authorship is generally considered to require more or less effort by other users.

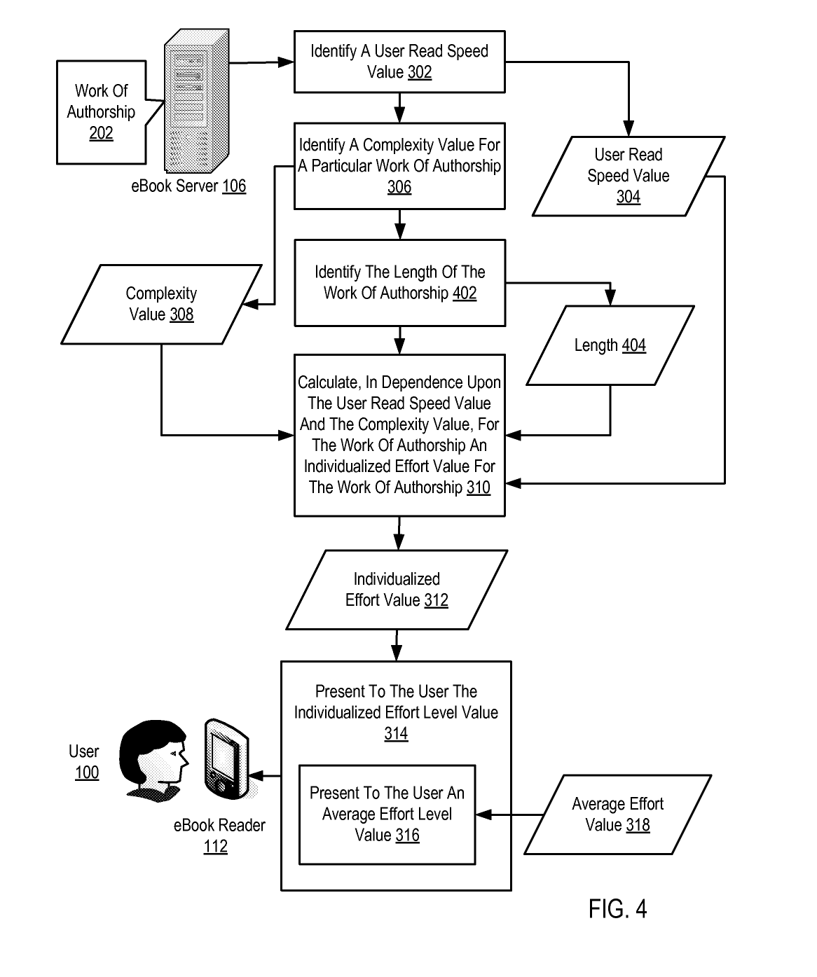

For further explanation, FIG. 4 sets forth a flow chart illustrating an additional example method for providing a user-specific effort value associated with digital textual content. The method of FIG. 4 is similar to the method of FIG. 3 in that the method of FIG. 4 includes identifying (302) a user read speed value (304); identifying (308) a complexity value (308) for a particular work of authorship (202); calculating (310), in dependence upon the user read speed value (304) and the complexity value (308), an individualized effort value (312) for the work of authorship (202); and presenting (314) to the user the individualized effort level value (312) including presenting (316) to the user an average effort level value (318) of other users.

The method of FIG. 4 differs from the method of FIG. 3 in that the method of FIG. 4 also includes identifying (402) a length of the work of authorship (202). Identifying (402) a length of the work of authorship (202) may be carried out by counting the number of words in the work of authorship.

In the method of FIG. 4 calculating (310) an individualized effort value (312) for the work of authorship (202) also includes calculating (310) an individualized effort value (312) for the work of authorship (202) in dependence upon the user read speed value (304), the length (404) of the work of authorship (202), and the complexity value (308). In the example of FIG. 4, a longer work of authorship may be weighted to increase an individualized effort value while a shorter work may be weighted to decrease an individualized effort value.

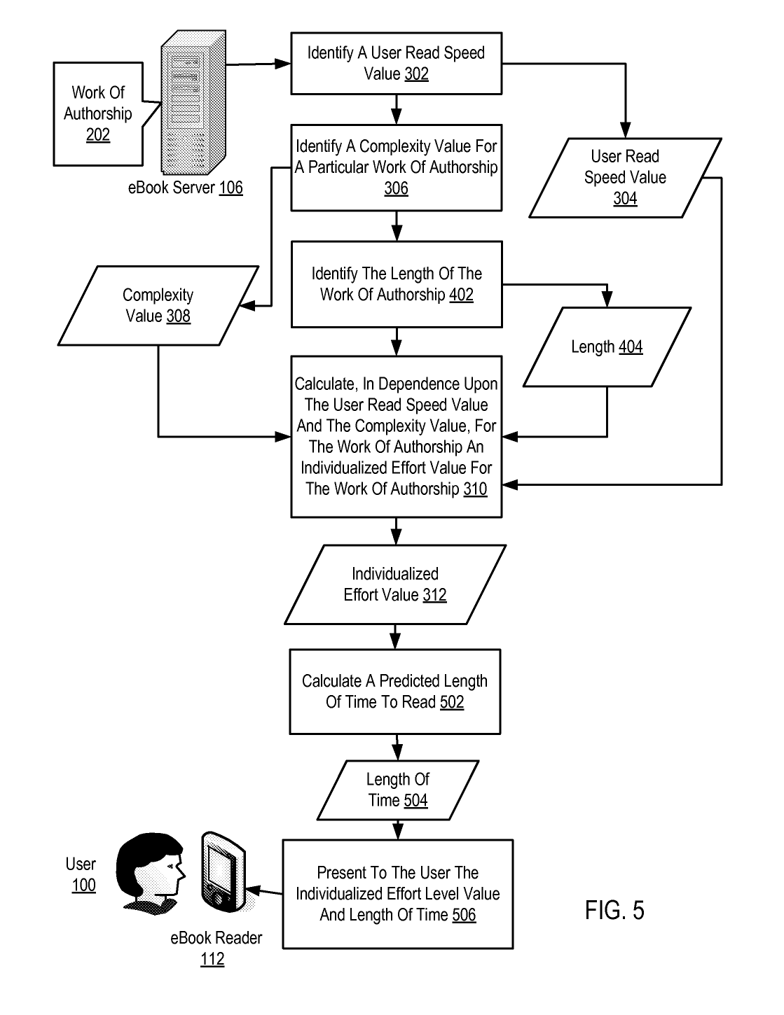

For further explanation, FIG. 5 sets forth a flow chart illustrating an additional example method for providing a user-specific effort value associated with digital textual content. The method of FIGS. 5 is similar to the methods of FIGS. 3 and 4 in that the method of FIG. 4 includes identifying (302) a user read speed value (304); identifying (308) a complexity value (308) for a particular work of authorship (202); calculating (310), in dependence upon the user read speed value (304) and the complexity value (308), an individualized effort value (312) for the work of authorship (202); and presenting (314) to the user the individualized effort level value (312).

The method of FIG. 5 differs from the method of FIGS. 3 and 4 in that the method of FIG. 5 includes calculating (502) a predicted length of time (504) to read the work of authorship (202) in dependence upon the read speed value (304) and the length (404) of the work of authorship (202). Calculating (502) a predicted length of time (504) to read the work of authorship (202) in dependence upon the read speed value (304) and the length (404) of the work of authorship (202) may be carried out using a formula that takes into account the user read speed and the length of the work of authorship. Such a formula may be carried out by dividing the number of words in the work of authorship by the user read speed. In some embodiments, calculating (502) a predicted length of time (504) to read the work of authorship (202) is also carried out in dependence upon the complexity value for the work of authorship. In such embodiments, more complex digital textual content is predicted to take a longer time to read then less complex digital textual content.

The method of FIG. 5 also includes presenting (506) to the user the individualized effort level value (312) and the predicted length of time (312). Presenting (506) to the user the individualized effort level value (312) and the predicted length of time (312) may be carried out by creating a presentation page including the individualized effort level value and the predicted length of time and transmitting the presentation page to a client device for display to the user.

Exemplary embodiments of the present invention are described largely in the context of a fully functional computer system for providing a user-specific effort value associated with digital textual content. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1-7. (canceled)

8. An apparatus for providing a user-specific effort value associated with digital textual content, the apparatus comprising a computer processor, a computer memory operatively coupled to the computer processor, the computer memory having disposed within it computer program instructions that, when executed by the computer processor, cause the apparatus to carry out the steps of:
identifying a user read speed value;
identifying a complexity value for a particular work of authorship; and
calculating, in dependence upon the user read speed value and the complexity value, an individualized effort value for the work of authorship.

9. The apparatus of claim 8 wherein identifying a user read speed value further comprises receiving from a user client device the user read speed value.

10. The apparatus of claim 8 wherein the computer memory has disposed within it computer program instructions that, when executed by the computer processor, cause the apparatus to carry out presenting to the user the individualized effort level value.

11. The apparatus of claim 10 wherein presenting to the user the individualized effort level value further comprises presenting to the user an average effort level value of other users.

12. The apparatus of claim 8 wherein the computer memory has disposed within it computer program instructions that, when executed by the computer processor, cause the apparatus to carry out identifying a length of the work of authorship and wherein:
calculating an individualized effort value for the work of authorship further comprises:
calculating an individualized effort value for the work of authorship in dependence upon the user read speed value, the length of the work of authorship, and the complexity value.

13. The apparatus of claim 12 wherein the computer memory has disposed within it computer program instructions that, when executed by the computer processor, cause the apparatus to carry out calculating a predicted length of time to read the work of authorship in dependence upon the read speed value and the length of the work of authorship.

14. The apparatus of claim 13 wherein the computer memory has disposed within it computer program instructions that, when executed by the computer processor, cause the apparatus to carry out presenting to the user the individualized effort level value and the predicted length of time.

15. A computer program product for providing a user-specific effort value associated with digital textual content, the computer program product disposed upon a computer readable medium, the computer program product comprising computer program instructions that, when executed, cause a computer to carry out the steps of:
identifying a user read speed value;
identifying a complexity value for a particular work of authorship; and
calculating, in dependence upon the user read speed value and the complexity value, an individualized effort value for the work of authorship.

16. The computer program product of claim 15 wherein identifying a user read speed value further comprises receiving from a user client device the user read speed value.

17. The computer program product of claim 15 further comprising computer program instructions that, when executed, cause a computer to carry out presenting to the user the individualized effort level value.

18. The computer program product of claim 15 wherein presenting to the user the individualized effort level value further comprises presenting to the user an average effort level value of other users.

19. The computer program product of claim 15 further comprising computer program instructions that, when executed, cause a computer to carry out identifying a length of the work of authorship and wherein:
calculating an individualized effort value for the work of authorship further comprises:
calculating an individualized effort value for the work of authorship in dependence upon the user read speed value, the length of the work of authorship, and the complexity value.

20. The computer program product of claim 19 further comprising computer program instructions that, when executed, cause a computer to carry out calculating a predicted length of time to read the work of authorship in dependence upon the read speed value, the complexity value, and the length of the work of authorship.
